(19) United States
(12) Patent Application Publication
(10) Pub. No.: US 2023/0114461 A1
(43) Pub. Date: Apr. 13, 2023

(54) System and procedure of Self-Governing HVAC Control technology

(71) Applicant: Nana Wilberforce, Mars, PA (US)

(72) Inventor: Nana Wilberforce, Mars, PA (US)

(21) Appl. No.: 17/496,803

(22) Filed: Oct. 8, 2021

(51) Int. Cl. F24F 11/63; G05B 13/02

(52) U.S. Cl. CPC F24F 11/63; G05B 13/0265

(57) ABSTRACT

Systems and methods are disclosed herein for completely automated system for energy management. The system uses advanced mathematical concepts and learning algorithms replacing all static rules-based software, to create an advance AI functionality based on unique feature of energy management system where the proposed system takes massive amounts of data to a central location and analyzes it. The core of the invention can be divided into using of artificial intelligence to maximize the flow of energy through a building and the management of the thermal balance of a building using dynamic modulation to improve occupant comfort and energy efficiency. The system aims to produce a 60 percent improvement in occupant comfort, a 35 percent reduction in carbon footprint, and a 30 percent increase in energy savings by using AI to continuously make micro-adjustments to your existing HVAC system.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever

### BACKGROUND

### Field of the Invention

Embodiments relate to the field of home energy management services and, in particular, to a system and particularly relates to a kind of control technology which uses advanced deep learning models to study your building, learn how it operates, identify potential opportunities for improvement, and then act on those.

### Description of the Related Art

According to the International Energy Outlook 2006, Report No. DOE/EIA-0484(2006) from the U.S. Dept. of Energy, the world's total net electricity consumption is expected to more than double during the period 2003-2030. Much of the electricity is expected to be used to provide industrial, institutional, commercial, warehouse and residential lighting. Adoption of energy-efficient technologies can help to conserve electricity thereby slowing the growth in both the “base demand” and “peak demand” components of electricity demand. Base demand is the steady-state, or average, demand for electricity, while peak demand occurs when the demand for electricity is the greatest, for example, during a hot summer day when electricity use for air conditioning is very high. Reducing either type of demand is desirable, but a reduction in peak demand generally is more valuable because of the relatively high unit cost of the capacity required to provide the peak demand.

Many facilities (e.g. commercial, residential, industrial, institutional, warehouses, etc.) typically include (or are being modified to include) artificial lighting devices such as high intensity fluorescent (“HIF”)lighting fixtures that reduce the amount of electricity consumed in comparison to other less efficient types of artificial lighting such as high intensity discharge (“HID”) lighting. Although similar equipment reduce the consumption of electricity required for operation, it is desirable to further reduce the electricity consumed by energy efficient equipment in a facility. Such energy efficient devices are often configured for control using relatively simplistic control schemes, such as “on” or “idle” during periods where the facility is regularly occupied, and “off” or “standby” when the facility is regularly unoccupied.

Energy providers, appliance manufacturers, consumers, and the government each desire to reduce peak power demands and save energy and cost. With the rapid advancements in technologies like smart grid, network communication, information infrastructures, bidirectional communication medium's, energy conservation methodologies and diverse techniques, Home area networks (HANs) have undergone a revolutionary change pertaining to various areas of power consumption domains like electricity usage patterns, energy conservation at consumption premises, etc. Under a robust smart grid paradigm, modern home equipped with HEMS contributes significantly towards efficiency improvement, economizing energy usage, reliability, as well as conserving energy for distributed systems. There are multiple inventions that have been proposed in prior art regarding development of Computational Intelligence Platform for Energy Resilience for everyday consumer.

For instance, a U.S. Pat. No. 6,522,955B1 on system and method for power management is issued to Jeffrey A. Colborn. The patent is on a system and method for power management is described that provides for monitoring and controlling a regenerative fuel cell and at least one powered device. The power management system includes a communication interface to facilitate data transmission, a communication device for monitoring and controlling a regenerative fuel cell and at least one powered device, the communication device providing for sending data to and receiving data from at least one powered device over a communication interface, a regenerative fuel cell for providing storage and supply of electricity, and a power interface for allowing electricity generated by the regenerative fuel cell to power at least one powered device.

A Home energy manager system bearing US patent 2,012,0053739A1 is issued to General Electric Co. The patent is on apparatus and method for managing energy of a home or other structure are disclosed. An energy management system for a home network comprises a central device controller configured to communicate with energy consuming devices, energy generation devices and storage devices at a home. Power/energy measuring devices provide consumption measurements for the home and each device to the controller. A user interface client application configured to provide real time information to a user/consumer and to an energy provider/utility about the consumption of the home, each device, and receives inputs to modify the controllers and/or the devices.

Another patent on System and method of compiling and organizing power consumption data and converting such data into one or more user actionable formats bearing U.S. Pat. No. 8,032,317B2 is issued to Generac Power System. The patent is on a method and system for use in creating a profile of, managing and understanding power consumption in a premise of a user, wherein said premise comprises two or more power consuming devices comprises measuring, via at least one sensor, aggregate energy consumption at the premise, receiving at a mobile computing device comprising a data processor, said aggregated signal from the sensor, collecting and recording the aggregate signal over a plurality of time resolutions and frequencies, therein to create a predicted aggregate signal for each time x and frequency y, detecting changes in the predicted aggregate signal at time x an frequency y (detected consumption pattern changes) and conveying to at least one of the user, a utility company, and other third party a notification of detected consumption pattern changes.

A US patent on Method and system for forecasting power requirements using granular metrics bearing U.S. Pat. No. 6,156,4839 is issued to Neurio Technology Inc. The patent is on a method for modeling power usage within a macrogrid uses data relating to the behavioral patterns and states (“BA”) of the users, data relating to external impacts on power usage and disaggregated power consumption data in at least one premises within the macrogrid (forming “power usage model data”) and thereafter a method of forecasting and predicting future power requirements within the macrogrid uses such power usage model data.

Another patent on On-board feature extraction and selection from high frequency electricity consumption data bearing US patent US 2,016,0080840 A1 is issued to Neurio Technology Inc. The patent is on Power consumption related data for the power source supplying an entire household or other group of appliances is captured at a relatively high data rate. The raw data is analyzed to remove redundancy and to identify pertinent features, and then the more informative of these features are then selected. The analysis and selection of features are pre-processing tasks that are performed on-site, on the same piece of hardware that acquires the raw data and transmits the pre-processed data to the server. By transmitting selective data to a remote server, only a low bandwidth is required for the transmission.

Another U.S. Pat. No. 6,633,823B2 on System and method for monitoring and controlling energy usage is issued to Nxegen Inc. The patent is on a system and method for real time monitoring and control of energy consumption at a number of facilities to allow aggregate control over the power consumption. A central location receives information over a communications network, such as a wireless network, from nodes placed at facilities. The nodes communicate with devices within the facility that monitor power consumption, and control electrical devices within the facility. The electrical devices may be activated or deactivated remotely by the central location. This provides the ability to load balance a power consumption grid and thereby proactively conserve power consumption as well as avoid expensive spikes in power consumption. The present invention also includes a wireless network for communicating with the number of facilities, and which allows other information to be collected and processed.

Another U.S. Pat. No. 7,177,728B2 on system and methods for maintaining power usage within a set allocation is issued to Jay Warren Gardner. The patent discusses an electric power management system includes a monitor for the total power usage of a facility that monitors a history of power consumption during a set time interval of a distribution system having at least one electric load. Predictions of available power are generated through out the time interval by comparing the history of power consumption to a set allocation. Available power predictions are transmitted to the at least one electric load. The at least one load control receives the power capability predictions and controls the energy usage of the at least one electric load such that the total energy usage of the facility does not exceed the set allocation.

A Chinese patent 1,024 98448B on home energy management system is issued to Chinese inventor. The patent discusses a home energy management system includes a database configured to store site report data received from a plurality of residential sites using a wireless home energy network at each site. Each residential site includes a thermostat accessible to the wireless home energy network. A processor is operably coupled to the database and configured to access the site report data and detect a current temperature set-point of the thermostat at a first residential site; detect a first seasonal profile of the thermostat; detect a current operating mode of a HVAC system operably coupled to the thermostat; and determine a thermostat schedule of the thermostat using the first seasonal profile and the current operating mode of the HVAC system.

Another patent on Intelligent power consumption information interactive management system is issued to Chinese inventor. The present invention provides an intelligent power management system of information exchange, including energy-saving devices and intelligent interactive terminals. The energy-saving device comprises a power saving switch, electric monitoring device, and a communication module; said energy saving switch, the electric monitoring device electrically connected to the communication module, the electric power consumption data monitoring device monitors the electrical equipment the communication module data to the electric interaction of the intelligent terminal, and receives the control instruction intelligent interaction terminal, transmitting said control command to said energy saving switch; the power saving switch according to the control instruction control device to switch between a power saving mode and a normal mode. The interactive terminal according to the intelligent power module of the communication data transmitted, the corresponding energy-saving device generates and transmits the control instruction. Information exchange intelligent power management system of the present invention can provide comprehensive monitoring of electricity consumption of electrical equipment, to better guide the rational use of electricity users.

A US patent on Energy management system and method bearing US patent 9,3608,74B2 is issued to Samsung Electronics Co Ltd. The patent is on a method of managing at least one network device at a site includes providing a web-based control selector to manage a detection module to control the at least one network device at the site. The method includes enabling the detection module in response to an enabled setting of the web-based control selector, and initiating a change in an operating condition of the at least one network device at the site in response to the enabled detection module and based on a detected presence of a user at the site. The method proceeds by disabling the detection module in response to the disabled web-based control selector.

There are multiple inventions that have been proposed in prior art regarding energy management system. However, the utility of these systems has not been seen in advance form and for the above discussed needs. Moreover, most of the existing smart home and building energy management systems implement stagnant and non-predictive control techniques and therefore struggle to adapt to changing environment. Furthermore, they are unable to handle large quantities of heterogeneous data from multiple sensors and extract the system's generalizable behavior and are therefore not effective as a predictive “energy efficiency” intelligence tool.

The current invention proposes a system which is the apparatus and method is based on unique feature of energy management system where the proposed system takes massive amounts of data to a central location and analyzes it. The technological aspects of the Akeptus self-governed HVAC control involve two fundamental processes: First, the use of artificial intelligence to maximize the flow of energy through a building. Second, the management of the thermal balance of a building using dynamic modulation to improve occupant comfort and energy efficiency.

None of the previous inventions and patents, taken either singly or in combination, is seen to describe the instant invention as claimed. Hence, the inventor of the present invention proposes to resolve and surmount existent technical difficulties to eliminate the aforementioned shortcomings of prior art.

### SUMMARY

In light of the disadvantages of the prior art, the following summary is provided to facilitate an understanding of some of the innovative features unique to the present invention and is not intended to be a full description. A full appreciation of the various aspects of the invention can be gained by taking the entire specification, claims, drawings, and abstract as a whole.

It is therefore the purpose of the invention to alleviate at least to some extent one or more of the aforementioned problems of the prior art and/or to provide the relevant public with a suitable alternative thereto having relative advantages.

The primary object of the invention is related to the provision of a self-governed HVAC control involving two fundamental processes: First, the use of artificial intelligence to maximize the flow of energy through a building.

Second, the management of the thermal balance of a building using dynamic modulation to improve occupant comfort and energy efficiency.

It is also the objective of the invention to provide an advance approach to facilitates the recording of high frequency raw data. The intelligent system makes good use of the high frequency data while using the current infrastructure with limited bandwidth and storage resources to transmit and store only the most informative of the raw data collected.

It is further the objective of invention to provide an effective solution to achieve significant energy efficiencies embrace energy efficiency as a dynamic resource and see the built environment as an ecosystem of interconnected components.

It is moreover the objective of the invention to provide a detailed analysis and method for monitoring an electricity supply comprising: receiving raw data from a sensor that senses the electricity supply; extracting features from the raw data by calculating feature vectors; selecting feature vectors of interest from the feature vectors; and transmitting the feature vectors of interest to a server.

It is also the objective of the invention to effectively manage the flow of energy through the buildings and maintain the right balance between occupant comfort and energy consumption.

It is further the objective of the invention to provide the ability of buildings to predict and prepare for upto 60 percent improvement in occupant comfort, a 35 percent reduction in carbon footprint, and a 30 percent increase in energy savings by using AI to continuously make micro-adjustments to your existing HVAC system.

It is also the objective of the invention to provide a constant monitoring of several data points and decide how to optimize the HVAC system in real-time, transforming your HVAC system from reactive to proactive.

It is moreover the objective of the system to use AI techniques to provide insights, patterns analysis, energy analysis through the intelligent Platform.

It is further the objective of the system to reduce stand-by consumption and thus saving the energy consumption.

It is further the objective of the invention to recommend adjustments that eliminate energy waste while keeping user comfortable.

It is moreover the objective of the invention to provide a system which is intelligent and allows to learn and self-adapt to previously unseen scenarios such as modifications in the habits or preferences of users or to changes in climate.

It is moreover the objective of the invention to provide real time geolocation ecosystem where the network application or program can be installed on any of the network devices.

It is further the objective of the invention system presents intelligent algorithms that does not require user-driven off-line training or manual configuration thereby needing minimal deployment effort.

It is also the objective of the invention to inform user when equipment requires maintenance, an energy consumption audit, or replacement.

It is further the objective of the invention to provide a system which brings ease of use and convenience for the user.

It is moreover the objective of the invention to provide a system which is of a durable and reliable system developed from complex and advance algorithms.

This Summary is provided merely for purposes of summarizing some example embodiments, so as to provide a basic understanding of some aspects of the subject matter described herein. Accordingly, it will be appreciated that the above-described features are merely examples and should not be construed to narrow the scope or spirit of the subject matter described herein in any way. Other features, aspects, and advantages of the subject matter described herein will become apparent from the following Detailed Description, Figures, and Claims.

### BRIEF DESCRIPTION OF DRAWINGS

The accompanying figures, where like reference numerals refer to identical or functionally similar elements throughout the separate views, together with the detailed description below, are incorporated in and form part of the specification, and serve to further illustrate embodiments of concepts that include the claimed invention and explain various principles and advantages of those embodiments.

FIG. 1 shows the process flow as per preferred embodiments of the invention.

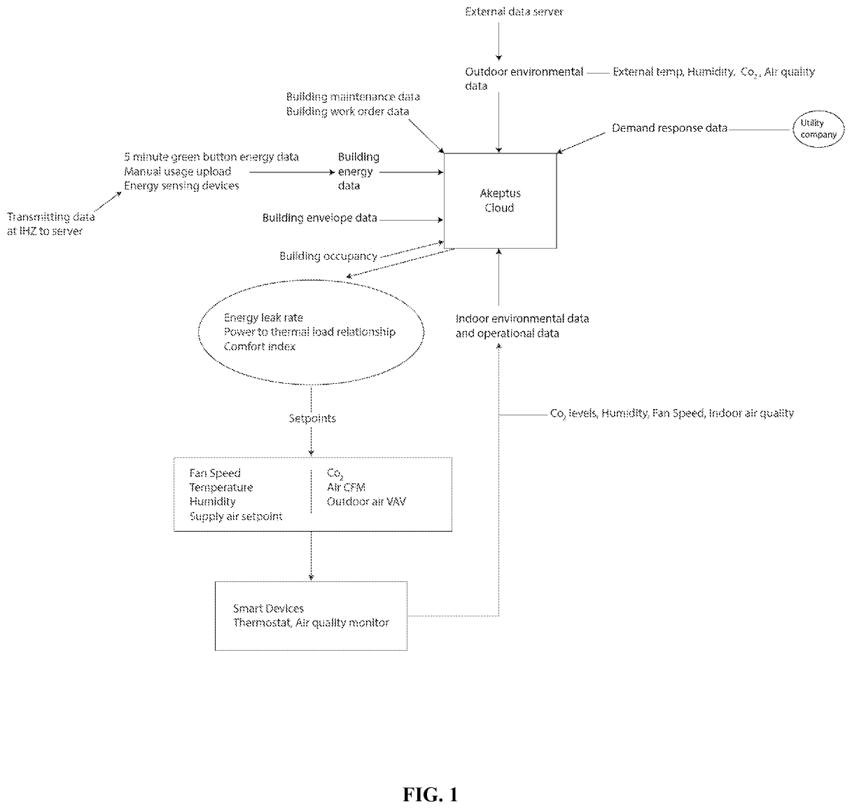

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION

Detailed descriptions of the preferred embodiment are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure or manner.

Many utilities are currently experiencing a shortage of electric generating capacity due to increasing consumer demand for electricity. Currently utilities charge a flat rate, but with increasing cost of fuel prices and high energy usage at certain parts of the day, utilities have to buy more energy to supply customers during peak demand. If peak demand can be lowered, then a potential huge cost savings can be achieved and the peak load that the utility has to accommodate is lessened. In order to reduce high peak power demand, many utilities have instituted time of use (TOU) metering and rates which include higher rates for energy usage during on-peak times and lower rates for energy usage during off-peak times. As a result, consumers are provided with an incentive to use electricity at off-peak times rather than on-peak times and to reduce overall energy consumption of appliances at all times.

Presently, to take advantage of the lower cost of electricity during off-peak times, a user manually operates power consuming devices during the off-peak times. However, a consumer may not always be present in the home to operate the devices during off-peak hours. In addition, the consumer may be required to manually track the current time to determine what hours are off-peak and on-peak.

Advancement in technology have increased the ability of consumers to monitor their electricity consumption. Electricity sensors are now widely available as consumer electronics, for monitoring the total electricity consumption of a household. Most of the sensors are capable of transmitting sensory data to a cloud service for potential analysis or other usage, but they typically have a data capture rate of 1 Hz or lower. Each sample of data captured may include parameters such as voltage, current, apparent power, reactive power and energy for each individual phase. Most homes have two and some have three phases. When a connection is reliable, the captured data is transmitted evenly, but when the connection is intermittent, the data can be transmitted in batches.

Home energy management (HEM) systems are becoming a key to reducing energy consumption in homes and buildings, in a consumer-friendly manner. Existing HEMs are commonly placed in one of two general categories:

In the first category, the HEM is in the form of a special custom configured computer with an integrated display, which communicates to devices in the home and stores data, and also has simple algorithms to enable energy reduction. This type of device may also include a keypad for data entry or the display may be a touch screen. In either arrangement, the display, computer and key pad (if used) are formed as a single unit. This single unit is either integrated in a unitary housing, or if the display is not in the same housing, the display and computer are otherwise connected/associated upon delivery from the factory and/or synchronized or tuned to work as a single unit.

In the second category, the HEM is in the form of a low cost router/gateway device in a home that collects information from devices within the home and sends it to a remote server and in return receives control commands from the remote server and transmits it to energy consuming devices in the home. In this category, again, as in the first, the HEM may be a custom configured device including a computer and integrated/associated display (and keypad, if used) designed as a single unit. Alternately, the HEM maybe implemented as home computer such as lap top or desk top operating software to customize the home computer this use.

Both of the current existing types have significant disadvantages due to higher consumer cost, low flexibility and increased system complexity.

The first category requires a large upfront cost to the consumer, because the cost of providing an integrated display on the HEM very expensive. In addition, the electronics required to drive the display is complex and expensive.

Further, from a consumer point of view, they are forced to add one more display screen to their home in addition to the home computer, smart phones, televisions and the displays on pre-existing home devices such as thermostats, appliance displays etc.

The second category of HEM involves a substantial cost to provide the server infrastructure and data transfer. In addition, this type of HEM must be connected continuously with a remote server otherwise energy data logging and energy saving commands for the devices in the home will be lost during service disruptions. In addition, this configuration requires connection to the Internet to access and view data. Therefore, this second configuration is very limiting in areas where Internet penetration is very low

The current invention in its preferred embodiment discloses an advance system allowing using advanced mathematical concepts and artificial intelligence to create a functional energy sensor describe system with on-board feature extraction and selection from high frequency electricity consumption data.

The system as per its preferred embodiments leverages on the principles of artificial Intelligence, capturing tens of thousands of data points. Embodiments discuss an intelligent energy management system that uses state-of-the-art smart technologies (sensors, actuators, controllers etc.) and Artificial Intelligence (AI) capabilities for optimal energy management.

The technological aspects of the Akeptus self-governed HVAC control involve two fundamental processes: First, the use of artificial intelligence to maximize the flow of energy through a building. Second, the management of the thermal balance of a building using dynamic modulation to improve occupant comfort and energy efficiency.

It seeks to achieve significant energy efficiencies must embrace energy efficiency as a dynamic resource and see the built environment as an ecosystem of interconnected components. By adopting this holistic and system-wide approach, organizations would be able to effectively manage the flow of energy through their buildings and maintain the right balance between occupant comfort and energy consumption. This means managing energy dynamically in terms of flow and modulating equipment performance in response to how internal and external environments change over time instead of using a static building and maintenance operating model. In physics, the law of the conservation of energy states that energy in a closed system is neither created nor destroyed but instead remains constant. When applied to the built environment, this means that energy, which can occur in different forms, such as electricity or sunlight, is continuously flowing into a building, being transformed into mechanical work or thermal energy, and then flowing out. Dynamically modulating the thermal balance of the building is a complex process that requires continuous optimization of the energy flow to ensure the comfort and maximum energy efficiency of the occupants.

The first steps toward keeping the building in balance are calculating its energy leakage rate and setting the ideal settings for the HVAC system to ensure optimum levels for the power-to-thermal load relationship. However, both the energy leakage rate and the power-to-thermal load relationship are changing over time as the various factors that affect the energy flow, such as occupancy, weather conditions, and demand, change. As a result, maintaining thermal balance effectively in a building requires finding ways to accurately predict how these inputs and outputs will change over time and ensuring all systems respond to the expected changes in the best possible way.

However, due to the complex nature of the energy flow, it is difficult to manually determine the building's thermal energy equation and manage the energy flow. The use of Artificial Intelligence (AI) is, therefore, an extremely effective way of maintaining a balanced thermal equation. One of the benefits of using AI in the building management area is that it can determine the thermal energy equation for a building within a fraction of the time required by an individual. The real value of AI occurs when it is used to predict how energy flow will evolve over time, and if it anticipates an unwanted thermal event in the future, it makes adjustments to the HVAC system to eliminate that event before it happens. In addition to determining which changes are best suited to ensure all occupants' comfort, the AI can also evaluate the optimum configuration of the HVAC system needed to achieve greater energy efficiency, thereby saving money and making buildings greener by reducing the load on the power grid.

The best way to characterize a building's collection of thermal balancing equations is to divide it into zones or divisions and then draw a group of equations for each zone. This requires the collection of historical data from the zones and the search for patterns in the data to isolate the habits and behavior of each zone. Once a specific energy leakage rate and power-to-thermal load relationship have been calculated for each zone, the next step is to aggregate all zone characterizations into a group of zones.

Per the laws of physics, thermal energy will always work to achieve balance, which means that energy will always flow across a differential to balance the amount of energy on either side. If the energy levels in the system are balanced, there is no flow. However, if the thermal energy on one side is higher than the other, energy will begin to flow through this differential at a specific rate until the balance is reached. There are barriers in the built environment, including walls and windows, that work to slow down this rebalancing. The rate of energy leakage is the rate at which energy moves across these barriers and measures the amount of heat that the built environment loses or gains over a given period. It is the rate at which energy flows into or out of a given zone. Each zone has its own unique leakage rate based on how it was constructed—including the types of materials used, such as insulation and windows—and its operation and maintenance. One of the keys to effective building management is the maintenance of the derived temperature of the conditioned space and the comfort of the occupants by continuously compensating for the leakage rate. This means if the energy is leaking out of the zone, maintaining that zone at the derived temperature will require thermal energy to be supplied to that zone at the same rate at which it is leaving. If the energy leaks into the zone because the outside temperature is higher, then you must cool the air and withdraw thermal energy at the same rate at which it enters.

Typically the power-to-thermal load refers to how efficiently the HVAC system converts power into thermal energy that it delivers to the various areas of the building. In building management, the relationship between the power that is fed into the engine and the air that it serves measures the efficiency of the engine in the HVAC system by maintaining the desired temperature. While the efficiency of the engine is primarily determined by the equipment that was purchased and how the equipment was installed, the operator can adjust various engine settings to optimize its performance. This relationship is dynamic in nature since the optimal power-to-thermal load relationship for a given zone depends on different internal and external conditions, such as occupancy and weather, which change over time. Maintaining a balanced thermal balance in a zone is, therefore, the most efficient and effective way to ensure occupants' comfort, save money, and reduce carbon footprint; this requires calculating the ideal configuration of the engine under all possible conditions for each zone within a building. The process involves providing the AI with all relevant data on the engine of the HVAC system, including performance data and areas within the building, including historical data on the level of occupancy and weather conditions. The AI will then calculate the ideal configuration of the engine from an efficiency perspective for all zones under all possible situations.

Having characterized all zones in a building, the next step as per its preferred embodiments is ensuring that each zone achieves thermal balance at all times and under changing conditions. This requires predicting future conditions within each zone according to selected variables, and then, in response to those predictions, making real-time adjustments to specific parts of the HVAC equipment to ensure that each zone always achieves thermal balance. Our deep learning method uses the leak-rate behavior of the zone, the power-to-thermal relationship, and what the AI has learned from historical data to make predictions about the future value of different parameters. These parameters may include any variables that building owners want to manage, including temperature levels, humidity levels, and concentration levels of different gases. From these predictions of the future values of crucial variables, the AI can make decisions on how to best manage the thermal balance for each zone in a building.

When the AI engine, based on its predictions, sees an unwanted event in the future that will disrupt the thermal balance in the zone, the engine will begin testing various micro-modifications of the HVAC system to determine the effects that different combinations of adjustments will have on future conditions in that zone. Our AI engine then uses the results of these tests to evaluate which combination of modifications to which parts of the equipment will eliminate the unwanted event most effectively over time. Once the correct course of action is determined, the algorithms then instruct the HVAC control system to modify the selected components to bring the zone to the desired condition.

The AI engine goes through the entire process again at a later time to check how the zone reacted to the changes. Using the thermal equation and the new conditions in the zone, it measures the changes to the specified variables and determines whether they actually affected the future in an intended way or led to the elimination of the unwanted event. The deep learning engine then tests all possible combinations of different modifications that could be applied to eliminate the predicted event. Once this is done, the AI will again select those adjustments that will reduce the expected event most effectively and instruct the HVAC control system to make the required adjustments in real-time.

The first steps toward keeping the building in balance are calculating its energy leakage rate and setting the ideal settings for the HVAC system to ensure optimum levels for the power-to-thermal load relationship. As described above, both the energy leakage rate and the power-to-thermal load relationship are changing over time due to the various factors that affect the energy flow, such as occupancy, weather conditions, and demand change. As a result, maintaining thermal balance effectively in a building requires finding ways to accurately predict how these inputs and outputs will change over time and ensuring all systems respond to expected changes in the best way possible. To effectively predict the occupancy of the building, we use our smart plug as a sensor to determine the occupancy of the workstation. These sensors only use energy data and occupancy data in a non-intrusive process. Continuously, the data, as mentioned above, is transferred to the cloud, and our Workplace AI module analyzes the data to provide workstation occupancy rates. This calculation is done on two-minute intervals and is aggregated for some time. Once the occupancy of the workstation has been determined, the result is aggregated to provide for the occupancy of the floor, the building, and the entire portfolio, resulting in metrics and insights, such as the average time of arrival, departure, and occupancy. Our AI engine then uses the results to evaluate which combinations of modifications to which parts of the equipment will provide employees the best comfort and efficiently run the equipment. Once the correct course of action has been determined, the algorithms then instruct the HVAC control system to modify the selected components to bring the zone to the desired condition.

While a specific embodiment has been shown and described, many variations are possible. With time, additional features may be employed. The particular shape or configuration of the platform or the interior configuration may be changed to suit the system or equipment with which it is used.

Having described the invention in detail, those skilled in the art will appreciate that modifications may be made to the invention without departing from its spirit. Therefore, it is not intended that the scope of the invention be limited to the specific embodiment illustrated and described. Rather, it is intended that the scope of this invention be determined by the appended claims and their equivalents.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separately claimed subject matter.

We claim:

1. An apparatus for monitoring an electricity supply comprising:
an input module configured to receive raw data from a sensor that senses the electricity supply;
an extractor module configured to extract features from the raw data by calculating feature vectors;
a selector module configured to select feature vectors of interest from the feature vectors;
a communication module configured to transmit the feature vectors of interest.

2. A system for uses advanced deep learning models to study your building, learn how it operates, identify potential opportunities for improvement, and then act on those comprising steps:
connects to building's HVAC system directly;
uses existing data from building systems (e.g., BMS, access control systems) and third-party sources (e.g., weather, occupancy) to guide decision-making;
operates building's HVAC system by writing back to the controller periodically without human intervention;
monitors several data points and decides how to optimize the HVAC system in real-time, transforming your HVAC system from reactive to proactive; and,
produces a 60 percent improvement in occupant comfort, a 35 percent reduction in carbon footprint, and a 30 percent increase in energy savings by using AI to continuously make micro-adjustments to your existing HVAC system.
